(19) United States
(12) Patent Application Publication
(10) Pub. No.: US 2006/0178111 A1
(43) Pub. Date: Aug. 10, 2006

(54) Apparatus and method for canceling noise in wireless transceiver

(75) Inventors: Hee-Chan Choi, Suwon-si (KR); Hyung-Weon Park, Seoul (KR)

Correspondence Address: DILWORTH & BARRESE, LLP, 333 EARLE OVINGTON BLVD., UNIONDALE, NY, 11553, US

(73) Assignee: SAMSUNG ELECTRONICS CO., LTD., Suwon-si (KR)

(21) Appl. No.: 11/330,752

(22) Filed: Jan. 12, 2006

(30) Foreign Application Priority Data
Jan. 12, 2005 (KR) 2005-2942

(51) Int. Cl. H04B 1/00; H04B 1/10

(52) U.S. Cl. 455/63.1; 455/295; 455/296

(57) ABSTRACT

A method of canceling noise of a reception module in a wireless transceiver including the steps of determining a filtering band using channel information; generating a switching control signal, selecting a filter to perform filtering according to the determined filtering band; and switching a receive signal received through an antenna of the reception module to the selected filter to perform the filtering using the switches controlled by the switching control signal; and filtering the receive signal using the selected filter. Accordingly, cross modulation (CM) noise of the reception module is canceled.

### PRIORITY

This application claims priority under 35 U.S.C. § 119 to an application entitled “Apparatus and Method for Canceling Noise in Wireless Transceiver” filed in the Korean Intellectual Property Office on Jan. 12, 2005 and assigned Serial No. 2005-2942, the contents of which are incorporated herein by reference.

### BACKGROUND OF THE INVENTION

1. Field of the Invention

The present invention relates generally to a wireless transceiver, and in particular, to an apparatus and method for canceling cross modulation (CM) noise caused by using a diversity technique.

2. Description of the Related Art

In general, a wireless transceiver includes antennas, circuits for emitting and receiving electronic waves, structural bodies, peripheral devices, etc. The wireless transceiver further includes an analog signal processing end for wirelessly transmitting data. A structure of the wireless transceiver will now be described with reference to FIG. 1.

FIG. 1 is a schematic diagram of a conventional wireless transceiver to which a diversity technique is applied. The wireless transceiver includes a transmitter 100 and a first receiver 110, which share a first antenna 111 through a duplexer 109. By adopting the diversity technique, a second antenna 121 is used, and the wireless transceiver further includes a second receiver 130 to process signals received through the second antenna 121.

The transmitter 100 includes a first mixer 101, a band pass filter (BPF) 103, a drive amplifier (DA) 105, and a power amplifier (PA) 107.

The first mixer 101 converts a baseband signal to a high frequency band signal and outputs the converted high frequency band signal to the BPF 103. The BPF 103 receives the high frequency band signal from the first mixer 101, filters a desired frequency band signal, and outputs the desired frequency band signal to the DA 105. The DA 105 generates a sufficient input power and outputs the sufficient input power to the PA 107 because the PA 107 is usually incapable of providing a sufficient gain due to its structure. The PA 107 power-amplifies a signal received from the DA 105, and outputs a signal having a sufficient power as required by the first antenna 111. The duplexer 109 receives the signal power-amplified by the PA 107 and outputs the received signal to the first antenna 111. The first antenna 111 then wirelessly radiates the received signal as an electromagnetic wave.

As previously described, the transmitter 100 and the first receiver 110 share the first antenna 111 through the duplexer 109. Herein, the duplexer 109 connects the transmitter 100, the first receiver 110, and the first antenna 111 to each other. Thus, the transmitter 100 and the first receiver 110, respectively, transmit or receive signals using the first antenna 111. That is, the duplexer 109 plays a role of a junction of the transmitter 100 and the first receiver 110 by using the single first antenna 111.

The first receiver 110 includes a low noise amplifier (LNA) 113, a BPF 115, and a second mixer 117. The first receiver 110 receives (through a conducting wire) an electric signal output from the duplex 109 receiving an electromagnetic wave from the air through the first antenna 111. The signal received through the first antenna 111 is input to the LNA 113. The LNA 113 amplifies the signal to which wireless channel noise is mixed so that amplification of the noise is attenuated and outputs the amplified signal to a BPF 115. The BPF 115 receives the signal output from the LNA 113, filters a desired frequency band signal, and outputs the filtered signal to a second mixer 117. The second mixer 117 converts the signal output from the BPF 115 to a baseband signal.

A typical process of transmitting and/or receiving a signal using the transmitter 100 and the first receiver 110 has been described. However, there is applied the diversity technique of receiving different signals using two different receive antennas to improve receiver performance.

That is, since a signal received through one antenna has a smooth fading effect though a signal received through the other antenna has a strong fading effect, the signal having the smooth fading effect is selected.

Thus, in addition to the first receiver 110 using the first antenna 111, the second antenna 121 and the second receiver 130 are added. The second receiver 130 includes an LNA 131, a high pass filter (HPF) 133, and a third mixer 135. Herein, for the sake of clarity, a description of components of the second receiver 130 which are the same as those of the first receiver 110 will be omitted.

A signal which is received through the second antenna 121 is processed in the same fashion as is a signal which is received through the first antenna 111. Herein, the HPF 133 is used rather than a BPF for packaging reasons as the HPF 133 allows a chip to be reduced in size as compared with using a BPF (e.g., BPF 115).

According to the wireless transceiver described above, cross modulation (CM) noise, which is a nonlinear component generated by passing through an active element, is generated. CM noise is an element to consider when determining sensitivity of a wireless transceiver. CM noise is primarily generated by a LNA and a mixer coupled thereto, from among active elements. A process of generating CM noise will now be described with reference to FIGS. 2A-2C.

FIGS. 2A, 2B and 2C are schematic diagrams illustrating steps for generating CM noise in the conventional wireless transceiver. Referring to FIG. 2A, for a receive signal, a transmit signal and the receive signal exist at a transmit signal frequency band and a receive signal frequency band, respectively. As described above, the transmit signal conducted in the receive signal is removed by isolation of a duplex or a BPF. Referring to FIG. 2B which shows the receive signal from which the transmit signal is removed, the transmit signal existing at the transmit signal frequency band is dramatically reduced.

The transmit signal remaining in the receive signal induces modulation with an in-band single tone jammer when passing through an LNA and a mixer, and then CM noise is generated as shown in FIG. 2C.

For the first receiver 110, CM noise in the LNA 113 is not a problem since the receive signal is sharply attenuated because of the isolation of the duplexer 109. In addition, generation of CM noise in the second mixer 117 is limited by attenuating the transmit signal once again by deploying the BPF 115 before the second mixer 117. However, unlike the first receiver 110 using the duplexer 109, the second receiver 130 implemented by a chip includes the HPF 133 instead of the BPF 115. Accordingly, undesired CM noise is still generated. Because of the generation of the undesired CM noise, two BPFs 123 and 125 in a front-end of the second receiver 130 are used to cancel some of the CM noise.

However, current communication systems use high band, i.e., broadband, wireless communication systems. As an example of a case of receiving a broadband signal, while a transmit signal attenuation rate of a radio frequency (RF) BPF of a wireless communication system whose bandwidth is 25 MHz is around −40 dB, the attenuation rate is around −19 dB when the bandwidth is 60 MHz.

Thus, according to conventional systems, when a broadband signal is received, even if the two BPFs 123 and 125 connected in series are used, a transmit signal attenuation rate which is worse than a transmit signal attenuation rate when using a single BPF results in actual operating conditions. Accordingly, CM noise remains a problem in conventional wireless transceivers.

### SUMMARY OF THE INVENTION

An object of the present invention is to provide an apparatus and method for canceling noise in a wireless transceiver.

Another object of the present invention is to provide an apparatus and method for canceling noise in a wireless transceiver having an expanded receiver structure.

A further object of the present invention is to provide an apparatus and method for canceling cross modulation (CM) noise in a wireless transceiver using a broadband signal.

According to one aspect of the present invention, there is provided an apparatus for canceling noise of a reception module in a wireless transceiver, the apparatus including a modem for determining a filtering band using channel information and for generating a switching control signal for the filtering; and a cross modulation (CM) noise canceller for receiving the switching control signal, switching a receive signal received through an antenna to perform band filtering of the receive signal in response to the switching control signal, and filtering the receive signal according to a band of the receive signal.

According to another aspect of the present invention, there is provided a method of canceling noise of a reception module in a wireless transceiver, the method including the steps of determining a filtering band using channel information; generating a switching control signal by determining a filter to perform filtering according to the filtering band; and switching a receive signal received through an antenna of the reception module to the filter to perform the filtering using the switching control signal and filtering the receive signal.

### BRIEF DESCRIPTION OF THE DRAWINGS

The above and other objects, features and advantages of the present invention will become more apparent from the following detailed description when taken in conjunction with the accompanying drawings in which:

FIG. 1 is a schematic diagram of a conventional wireless transceiver to which a diversity technique is applied;

FIGS. 2A, 2B and 2C are schematic diagrams illustrating steps of generating the CM noise in the conventional wireless transceiver;

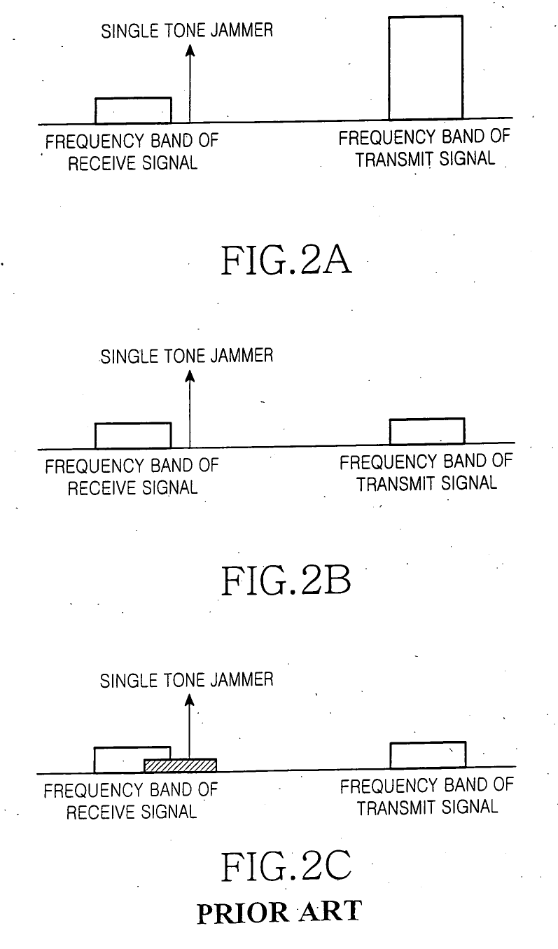

FIG. 3 is a schematic diagram of a reception module for canceling CM noise in a wireless transceiver according to a preferred embodiment of the present invention;

FIG. 4 is a schematic diagram of a CM noise canceller and a modem according to another preferred embodiment of the present invention;

FIG. 5 is a schematic diagram of a CM noise canceller and the modem according to another preferred embodiment of the present invention;

FIG. 6 is a schematic diagram of operational bands of a BPF module according to a preferred embodiment of the present invention; and

FIG. 7 is a flowchart illustrating a process of canceling CM noise in a wireless transceiver.

### DETAILED DESCRIPTION OF THE PREFERRED EMBODIMENT

Preferred embodiments of the present invention will be described herein below with reference to the accompanying drawings. In the drawings, the same or similar elements are denoted by the same reference numerals even though they are depicted in different drawings. In the following description, well-known functions or constructions are not described in detail since they would obscure the invention in unnecessary detail.

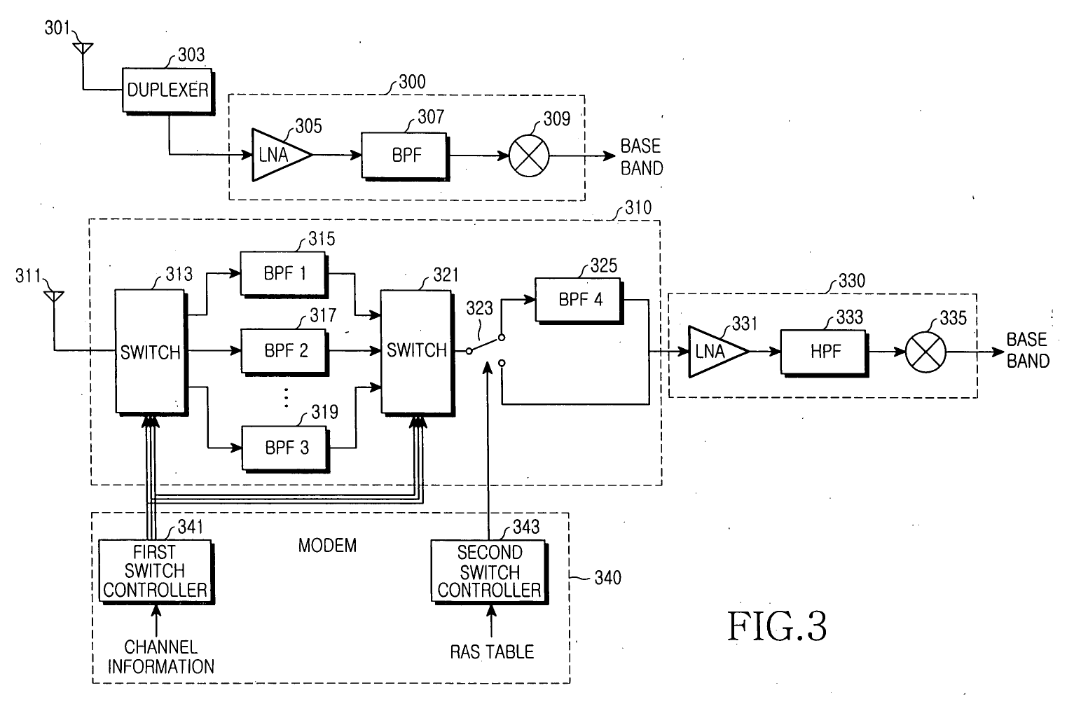

In the present invention, generation cross modulation (CM) noise in a wireless transceiver is reduced. A reception module of the wireless transceiver receives a broadband signal using a CM noise canceller in which conventional band pass filters (BPFs) are connected in parallel. The CM noise canceller is deployed between an antenna added by adopting a diversity technique and a second receiver. A structure of a reception module including the CM noise canceller will now be described with reference to FIG. 3.

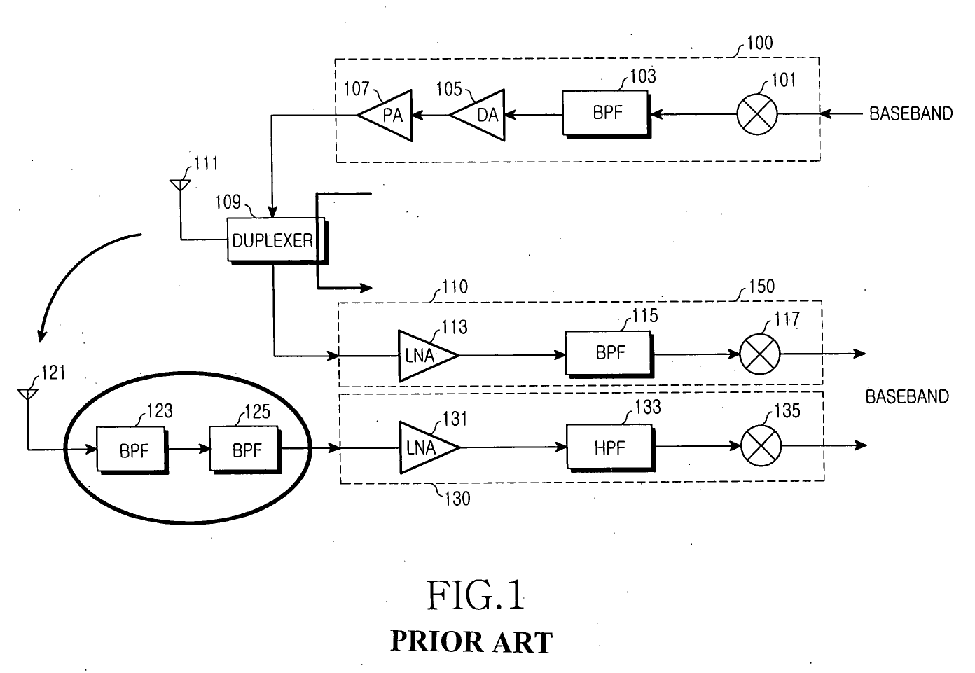

Referring to FIG. 3 the reception module includes two receivers adopting the diversity technique, i.e., a first receiver 300 and a second receiver 330. The first receiver 300 shares a first antenna 301 with a transmitter (not shown) having the same structure as that of the transmitter shown in FIG. 1 through a duplexer 303. Since the transmitter performs the same operation as that of the transmitter shown in FIG. 1, a detailed description of the transmitter is omitted for the sake of clarity. Likewise, a detailed description of components included in the first receiver 300 and second receiver 330, which is related to the same configuration and operation illustrated in FIG. 1, is also omitted for the sake of clarity.

The first receiver 300 includes a low noise amplifier (LNA) 305, a BPF 307, and a second mixer 309. The first receiver 300 receives (through a conducting wire) an electric signal output from the duplexer 303 receiving an electromagnetic wave from the air through the first antenna 301. The first receiver 300 converts a receive signal to a baseband signal.

If a radio frequency (RF) module operates in a single receive mode (i.e., a mode using only a single antenna), the second receiver 330 does not operate. However, if the RF module operates in a diversity receive mode, the second receiver 330 receives a signal through a second antenna 311. Herein, a receive signal received through the second antenna 311 is input to the second receiver 330 by passing through a CM noise canceller 310.

The CM noise canceller 310 includes a first switch 313 for controlling an input of a BPF module including BPFs configured in parallel, the BPF module including a first BPF 315, a second BPF 317, and a third BPF 319, which are configured in parallel, a second switch 321 for controlling an output of the BPF module, a fourth BPF 325, and a third switch 323 for receiving a control signal according to an operation of the transmitter and controlling whether a fourth BPF 325 is bypassed.

The CM noise canceller 310 operates by receiving control signals from a modem 340. The modem 340 includes a first switch controller 341 and a second switch controller 343. The modem 340 has channel information, and the first switch controller 341 receives, and uses, the channel information. Thus, the first switch controller 341 uses the channel information, i.e., information on a frequency band used in the wireless transceiver and controls switch 313 accordingly. That is, the first switch controller 341 reads information on a BPF (e.g., BPFs 315-319), which can filter a band corresponding to a frequency band of the receive signal, from a predetermined buffer included in the modem 340 and determines a filtering band based on the channel information. Also, the first switch controller 341 selects a BPF to perform filtering based on the determined band and generates a switching control signal for the selection. The first switch controller 341 generates the switching control signal and transmits the switching control signal to each of the first switch 313 and the second switch 321 to perform a switching operation using a determined BPF. Herein, a transmission operation of the switching control signal will now be described as an example, the first switch 313 and the second switch 321 are controlled using high/low signals. The number of control wires to transmit the switching control signal depends on the number of paths of a signal passing through the first switch 313 and the second switch 321, i.e., the number of BPFs. The method of controlling the first switch 313 and the second switch 321 by the first switch controller 341 described above is described as an example and should not be construed as being limited to the above description.

The first switch controller 341 controls a filtering path of the receive signal received through the second antenna 311 by transmitting the switching control signal to the first switch 313 and the second switch 321. The BPF module includes the first BPF 315, the second BPF 317, and the third BPF 319 connected in parallel, each having a reference band. The BPF module performs the filtering operation by selecting a BPF corresponding to a band of the receive signal received through the second antenna 311 using the switching control signal received from the first switch controller 341. In alternative embodiments, the BPF module includes more than 3 BPF's.

While the first switch 313 controls an input of the BPF module 350, the second switch 321 controls an output of the BPF module. Thus, the second switch 321 also receives the switching control signal from the first switch controller 341 and switches an output signal according to a filtering path controlled by the first switch 313. Accordingly, even if a signal received by the reception module is a broadband signal, by using the BPF module, which includes BPFs (e.g., BPF 315-319) each having different center frequencies and predetermined filtering bands in parallel, the CM noise canceller 310 performs filtering according to a band of the broadband signal, thereby not contributing to CM noise.

The second switch controller 343 included in the modem 340 extracts an automatic gain control (AGC) level from an RF analog subsystem (RAS) table of the modem 340. Herein, the RAS table is a table containing AGC levels to compensate for an AGC characteristic of an RF amplifier (AMP) (not shown) located on a signal path of the RF module so that the AGC characteristic is linear. Thus, the second switch controller 343 receives the AGC level and compares the AGC level with a predetermined reference value pre-stored in a buffer to determine whether the fourth BPF 325 is to be bypassed. Herein, the predetermined reference value is a pre-set value matched to a system environment or characteristic considering generation of the CM noise. If the AGC level is equal to or greater than the predetermined reference value, the second switch controller 343 transmits a switching control signal for an output signal of the second switch 321 to be band pass filtered by the fourth BPF 325 to the third switch 323, and if the AGC level is less than the reference value or if the transmitter does not operate, the second switch controller 343 transmits a switching control signal to the third switch 323 so that the output signal of the second switch 321 bypasses, (i.e., does not pass to) the fourth BPF 325. In other words, the second switch controller 343 transmits the switching control signal to the third switch 323 so that the fourth BPF 325 can filters the output signal of the second switch 321 according to whether a transmit signal exists, and also according to the transmit signals level, using information on the transmit signal, which is stored in the modem 343.

As a result, the third switch 323 operates by receiving the switching control signal from the second switch controller 343 and also controls the output signal of the second switch 321.

An output signal of the CM noise canceller 310 is input to the second receiver 330. Unless an operation of the diversity receive mode stops, the CM noise canceller 310 continuously performs an operation of filtering a receive signal received through the second antenna 311 by receiving the switching control signals from the modem 340.

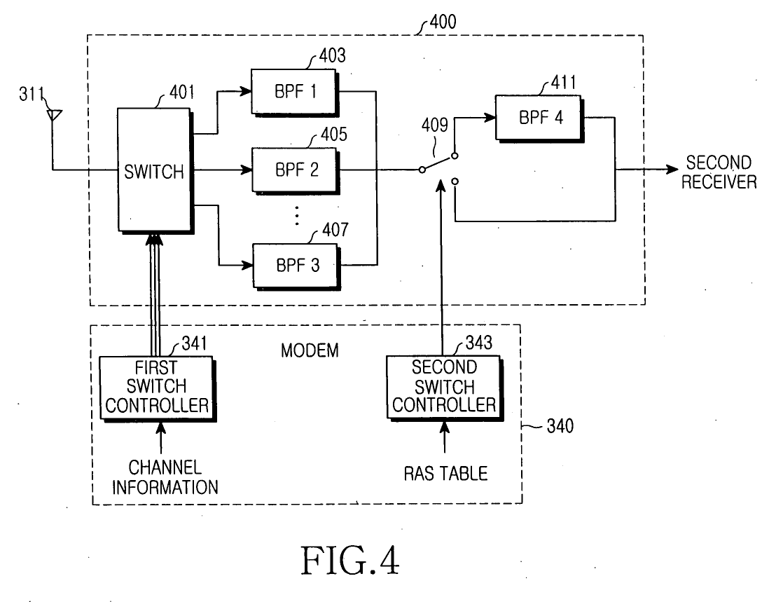

The second receiver 330 includes an LNA 331, an HPF 333, and a third mixer 335. The second receiver 330, receives the output signal of the CM noise canceller 310, and converts the signal to a baseband signal through a series of processes. Accordingly, if a signal is received through the second antenna 311 using the CM noise canceller 310, even if the signal is a broadband signal, CM noise is not generated. A structure of the CM noise canceller 310 according to another embodiment of the present invention will now be described with reference to FIG. 4.

FIG. 4 is a schematic diagram of a CM noise canceller 400 and the modem 340 according to another preferred embodiment of the present invention. The CM noise canceller 400 receives a receive signal through the second antenna 311 and band-pass-filters the receive signal.

The CM noise canceller 400 includes a first switch 401 for controlling an input of a BPF module including BPFs configured in parallel. The BPF module includes a first BPF 403, a second BPF 405, and a third BPF 407, which are configured in parallel, a fourth PBF 411, and a second switch 409 for receiving a control signal according to an operation of the transmitter and controlling whether the fourth BPF 411 is bypassed.

The CM noise canceller 400 operates by receiving a receive signal through the second antenna 311 and receiving control signals from the modem 340 illustrated in FIG. 3. The first switch 401 receives a control signal from the first switch controller 341. Since an operation of the modem 340 generating the control signals has been described in detail in FIG. 3, for the sake of clarity, a detailed description has been omitted.

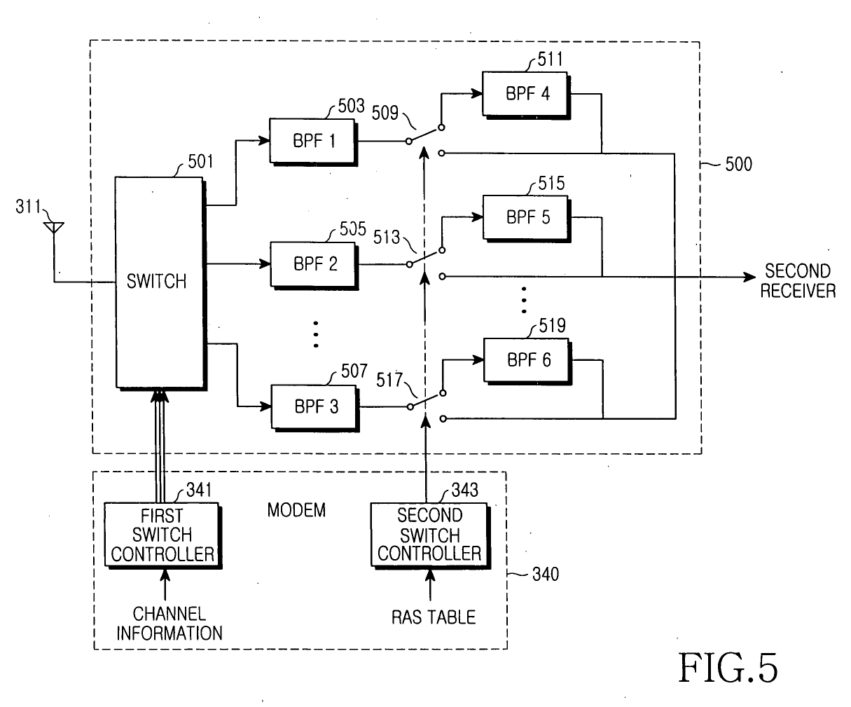

The first switch controller 341 included in the modem 340 determines an operating BPF (e.g., selects a BPF from BPF's 403-407) using the channel information and transmits the control signal to the first switch 401 to switch to the determined BPF. The first switch 401 receives the control signal and controls an input of the BPF module including the BPFs 403, 405 and 407 configured in parallel. The first BPF 403, the second BPF 405, and the third BPF 407 are configured in parallel, each having a reference band. After the BPF module performs the filtering according to each channel band, the second switch controller 343 included in the modem 340 transmits a switching control signal for determining whether the fourth BPF 411 is bypassed using a transmit AGC level to the second switch 409. The second switch 409 operates by receiving the switching control signal. If the transmit AGC level is less than a predetermined reference value or if the transmitter does not operate, the fourth BPF 411 is bypassed, and if the transmit AGC level is equal to or greater than the predetermined reference value, a filtering operation is performed using the fourth BPF 411. Thereafter, an output signal of the CM noise canceller 400 is input to the second receiver 330 (see FIG. 3). Unlike the structure in which the BPF module 450 is controlled using two switches as shown in FIG. 3, in FIG. 4, the CM noise canceller 400 is constructed using only a single switch (i.e., the first switch 401) for controlling the input signal of the BPF module 450. A structure of the CM noise canceller 310 according to another embodiment of the present invention will now be described with reference to FIG. 5.

FIG. 5 is a schematic diagram of a CM noise canceller 500 and the modem 340 according to another preferred embodiment of the present invention. The CM noise canceller 500 receives a receive signal through the second antenna 311 and band-pass-filters the receive signal.

The CM noise canceller 500 includes a first switch 501 for controlling an input of a BPF module which includes a first BPF 503, a second BPF 505, and a third BPF 507, which are configured in parallel, second, third and fourth switches 509, 513 and 517, respectively for receiving a control signal according to an operation of the transmitter and controlling whether a corresponding BPF is bypassed, and fourth, fifth and sixth BPFs 511, 515 and 519, respectively.

The CM noise canceller 500 operates by receiving a receive signal through the second antenna 311 and receiving control signals from the modem 340 illustrated in FIGS. 3-5. The first switch 501 receives a control signal from the first switch controller 341. Since an operation of the modem 340 generating the control signals has been described in detail in FIG. 3, for the sake of clarity, its detailed description has been omitted.

The first switch controller 341 included in the modem 340 determines an operating BPF using the channel information and transmits the control signal to the first switch 501 to switch to the operating BPF. The first switch 501 receives the control signal and controls an input of the BPF module including the BPFs 503, 505 and 507 configured in parallel. The first BPF 503, the second BPF 505, and the third BPF 507 are configured in parallel, each having a reference band.

After the BPF module performs the filtering according to each channel band, the second switch controller 343 included in the modem 340 transmits a switching control signal for controlling whether the fourth, fifth and sixth BPFs 511, 515 and 519 are respectively bypassed using the second, third and fourth switches 509, 513 and 517. The second, third and fourth switches 509, 513 and 517 operate by receiving the switching control signal. If the transmit AGC level is less than the a predetermined reference value or if the transmitter does not operate, the fourth, fifth and sixth BPFs 511, 515 and 519 are bypassed, and if the transmit AGC level is equal to or greater than the predetermined reference value, a filtering operation is performed using the fourth, fifth and sixth BPFs 511, 515 and 519 respectively.

Thereafter, an output signal of the CM noise canceller 500 is input to the second receiver 330. In the present embodiment, the CM noise canceller 400 is constructed so that the input signal of the BPF module is controlled using only a single switch (i.e., the first switch 501) and the output signal of the BPF module is switched using a plurality of switches (i.e., second, third and fourth switches 509-517 respectively) so that the output signal is either bypassed or band-pass-filtered. The output signal is band-passed-filtered using a plurality of BPFs (e.g., BPFs 522-519) corresponding to the number of BPFs of the BPF module. The number of switches correspond to the number of BPFs in the BPF module.

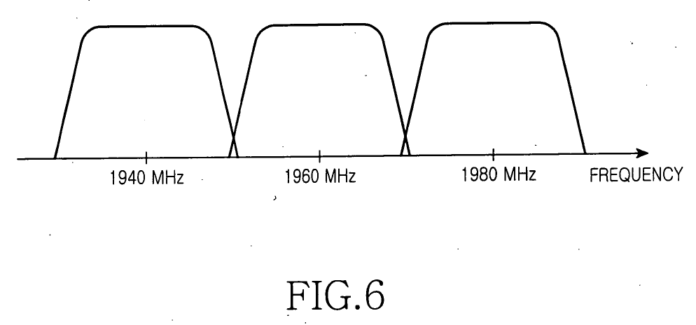

An operation of BPFs, which are configured in parallel, of the BPF module included in the CM noise canceller described above will now be described with emphasis on a frequency band with reference to FIG. 6.

FIG. 6 is a schematic diagram of operational bands of the BPF module according to a preferred embodiment of the present invention. A description of the operation of the parallel configured BPFs in the BPF modules of FIGS. 3-5 will now be given with reference to an arbitrary frequency band. As an example, the number of BPFs of the BPF module is 3. In addition, as an example, a signal received by the reception module is a United States (US) personal communication service (PCS) receive frequency. The US PCS receive frequency band is 1930 MHz to 1990 MHz, and if the US PCS receive frequency band is received using three BPFs, a first BPF has a center frequency of 1940 MHz and filters a signal having a 20 MHz bandwidth located about its center frequency, a second BPF has a center frequency of 1960 MHz and filters a signal having a 20 MHz bandwidth located about its center frequency, and a third BPF has a center frequency of 1960 MHz and filters a signal having a 20 MHz bandwidth located about its center frequency.

The first switch controller included in the modem extracts a frequency band of a channel received by the reception module using channel information received from the modem. Then, the first switch controller transmits a control signal to the switch(es) to perform a switching operation of the BPF module so that a signal of the frequency band is filtered using a corresponding BPF that can filter the frequency band. Thus, CM noise can be canceled by filtering a broadband signal using BPFs connected in parallel, each having a predetermined center frequency and a predetermined bandwidth. The number of BPFs, operational areas and the receive signal described in FIG. 6 are used for the convenience of description only and should not be construed as limiting the description. Although only three parallel BPFs have been shown in the aforementioned embodiments, in alternative embodiments, it is envisioned that any number of parallel BPFs can be used as required by design and/or system environments or standards.

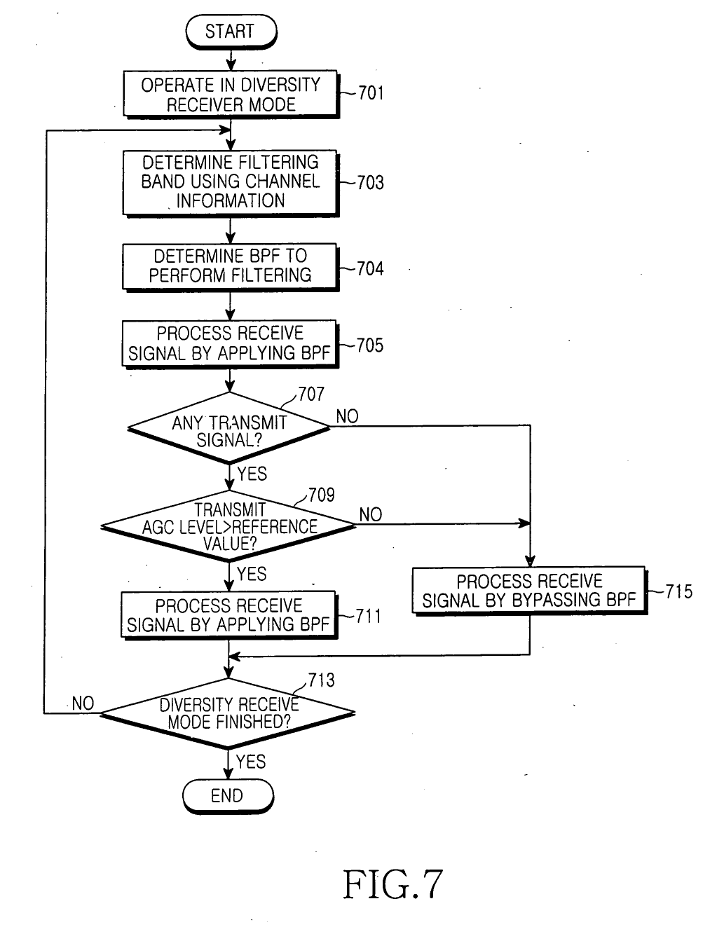

FIG. 7 is a flowchart illustrating a process of canceling CM noise in a wireless transceiver.

Before referring to FIG. 7, various embodiments for a CM noise canceller are suggested in the present invention. However, since a structure of using a plurality of BPFs connected in parallel and an operation of a second receiver receiving control signals from a modem are similar to each other though their configuration are somewhat different from each other, an operational process on the second antenna 311, the CM noise canceller 310, the second receiver 330 and the modem 340 illustrated in FIG. 3 will now be described.

Referring to FIG. 7, when the RF module uses a single antenna in the single receive mode, the RF module processes a receive signal using the first receiver 300. However, when the RF module performs in the diversity receive mode (e.g., due to a user's request or a change of a wireless transmit/receive medium) using the second antenna 311, the second antenna 311, the CM noise canceller 310, the second receiver 330 and the modem 340 perform an operation for canceling CM noise in step 701.

According to the operation in the diversity receiver mode, the first switch controller 341 included in the modem 340 receives channel information. Thereafter, the first switch controller 341 determines a filtering band using the channel information in step 703. The first switch controller 341 also determines a BPF to perform the filtering in step 704. Herein, the BPF has a predetermined center frequency and receives a signal of a predetermined bandwidth, and as described above, a band-limited filter to perform the filtering is selected as the BPF among band-limited filters connected in parallel, each having a different center frequency. Thereafter, the first switch controller 341 transmits a control signal to the first and second switches 313 and 321 to control an input signal to the BPF module and an output signal from the BPF module 350. The first and second switches 313 and 321 perform a switching operation to input and output the receive signal received through the second antenna 311 to and from BPFs of the BPF module using the control signal. A BPF according to each channel is applied to the receive signal received through the second antenna 311 using the channel information used by the reception module in step 705. Then, a signal corresponding to the receive channel is band-pass-filtered. The second switch controller 343 included in the modem 340 determines whether a transmit signal from the transmitter exists in step 707. If the transmit signal from the transmitter does not exist, the receive signal is controlled to bypass the fourth BPF 325 and to be provided to the second receiver 330 in step 715. However, if the transmit signal from the transmitter exists, the second switch controller 343 included in the modem 340 receives a transmit AGC level from the RAS table and determines whether the transmit AGC level is greater than a predetermined reference value stored in the modem 340 by comparing the transmit AGC level with the predetermined reference value in step 709. If the transmit AGC level is less than or equal to the predetermined reference value, the receive signal is controlled to bypass the fourth BPF 325 and to be provided to the second receiver 330 in step 715. However, if the transmit AGC level is greater than the predetermined reference value, a signal obtained by band-pass-filtering the receive signal according to the channel should be band-pass-filtered once more. Thus, the second switch controller 343 transmits a control signal to the third switch 323 so that the signal passed through the BPF module is band-pass-filtered by the fourth BPF 324 and provided to the second receiver 330 in step 711. It is determined whether the diversity receiver mode is finished by receiving a diversity receiver mode release request in step 713. If the diversity receiver mode is not finished as a result of the determination, the first and second switch controller 341 and 343 continuously perform the above operation.

As described above, according to embodiments of the present invention, by constructing BPFs connected in parallel, with each BFP having a different center frequency band, to cancel CM noise according to a diversity technique, problems due to the CM noise are not generated even if a broadband signal is received. In addition, a CM noise canceller having the flexibility of selectively receiving a predetermined frequency band by using only a selected BPF of a plurality of BPFs according to a receive signal due to the CM's parallel BPF structure can be easily constructed.

While the invention has been shown and described with reference to a certain preferred embodiment thereof, it will be understood by those skilled in the art that various changes in form and details may be made therein without departing from the spirit and scope of the invention as defined by the appended claims.

What is claimed is:

1. An apparatus for canceling noise of a reception module in a wireless transceiver, the apparatus comprising:
a modem for determining a filtering band using channel information and for generating a switching control signal for selecting the determined filtering band; and
a cross modulation (CM) noise canceller for receiving the switching control signal, switching a receive signal received through an antenna to perform band filtering of the receive signal in response to the switching control signal, and filtering the receive signal according to a band of the receive signal.

2. The apparatus of claim 1, wherein the channel information is information on a receive frequency band of the wireless transceiver.

3. The apparatus of claim 1, wherein the modem comprises a switch controller for determining a filtering band using the channel information, generating the switching control signal for performing the filtering according to the filtering band, and controlling a switching operation.

4. The apparatus of claims 1, wherein the CM noise canceller comprises:
a band pass filter (BPF) module for filtering the receive signal received through the antenna, the BPF module including a plurality of BPFs connected in parallel, each of the BPFs for filtering a predetermined band; and
a switch for receiving the switching control signal from the modem and for controlling an input of the BPF module.

5. The apparatus of claim 4, wherein at least two of the BPFs have different center frequencies.

6. The apparatus of claim 4, further comprising:
a second switch for receiving the switching control signal from the modem and for controlling an output of the BPF module.

7. A method of canceling noise of a reception module in a wireless transceiver, the method comprising the steps of:
determining a filtering band using channel information;
selecting a filter to perform filtering according to the filtering band, and generating a switching control signal; and
switching, based on the switching control signal, a receive signal received through an antenna of the reception module to the selected filter and filtering, by the selected filter, the receive signal.

8. The method of claim 7, wherein the channel information is information on a receive frequency band of the wireless transceiver.
